(19) United States
(12) Patent Application Publication
(10) Pub. No.: US 2008/0209403 A1
(43) Pub. Date: Aug. 28, 2008

(54) PROFILING APPARATUS AND PROFILING PROGRAM

(75) Inventor: Shigeru Kimura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/033,975

(22) Filed: Feb. 20, 2008

(30) Foreign Application Priority Data
Feb. 23, 2007 (JP) 2007-43962

(51) Int. Cl. G06F 9/44

(52) U.S. Cl. 717/125

(57) ABSTRACT

A profiling apparatus including a program execution section that executes an target program, an interrupt generation section that generates an interruption every predetermined time, a gathering section that is activated upon occurrence of the interruption to gather a data access destination in the target program and a number of interruptions at the data access destination, and a display section that displays information gathered by the gathering section.

### BACKGROUND

1. Field

The embodiments discussed herein are directed to a profiling apparatus and a profiling program, and, more particularly, to a profiling apparatus and a profiling program which can operate in a real machine environment.

2. Description of the Related Art

Profiling is widely used as means of analyzing the performance of a computer system and means of optimizing of a computer system. Profiling is effective in analyzing the running frequency of a program code as a target, the time distribution thereof, and the intra-call relation frequency of a program. There are two general profiling schemes.

One scheme is to insert a profiling code into a compiler to get execution information (see FIG. 1). This profiling scheme is generally used, and is often implemented in a compiler product as a standard function. Some ways of improving the data gathering efficiency for the profiling scheme—have been proposed (see, for example, JP-A-11-212837).

However, the compiler-based profiling code insertion system has a problem—in that because a profiling process is performed for all target codes, a time overhead occurs. In other words, the code insertion brings about an operational difference or a memory allocation difference with respect to the original program binary. The operation often differs from the original operation, particularly in a program for communications or the like in which timings are important, so that the usage may be restricted according to the accuracy needed.

The other profiling scheme is sampling-based profiling using a hardware timer or a mechanism for monitoring the performance of a CPU (Central Processing Unit). According to the profiling scheme, a sampling interruption is generated every given time or every time the number of execution instructions, the number of cache misses or the like reaches a given value. The number of execution instructions or cache misses can be measured by a processor or a peripheral circuit. A profiling program is registered as an interruption process records an execution instruction address or the like at the time of occurrence of the interruption, thereby extracting a code range which has been spent most statistically, a range of codes which have been executed most frequently, or the like (see, for example, JP-A-6-342386). There also is a scheme of generating an interruption for each branch instruction (see, for example, JP-A-11-327951). A target code need not be altered, however, in the sampling-based profiling system, so that the overhead problem and the memory allocation problem can be minimized while paths to an execution instruction address at the time of sampling and their call relation cannot be acquired or are not perfect.

The above has described the schemes of specifying the location of a process which involves a high execution cost on a program code, or the location of a program code. There is also a method of tuning a program on allocation of data to be accessed from a program. This tuning method involves reference to a memory at the time of accessing data from the program. According to the tuning method a data cache memory is installed to reduce the memory access cost. The data once accessed is left stored in the cache memory which is accessible at a high speed. When a memory access request for the data is made again, the data is acquired from the cache memory, not directly from the memory. The use of the data cache memory reduces the number of accesses to the main memory, thereby reducing the power consumption originating from the memory access as well as improving the performance. Various data allocation schemes have been studied to reduce cache memory misses in the method of using a data cache memory (see, for example, JA-A-2005-122506).

There is an idea contrived on a data layout method for allocating parallelizable parts of a program to a plurality of processing elements. The program may be described in a literal type language. The processing elements may constitute distributed memory type parallel computers. A distributed arrangement of laid-out data needed to process the parts at the time of converting the program into codes for the parallel computers may be effected (see, for example, JP-A-9-282290).

Arranging for high-frequency access data to a fast memory from a slow memory improves the performance of a processor which has both the fast memory and slow memory. Likewise, arranging for high-frequency access data to a low-power memory from a high-power memory can reduce consumed power. As is obvious from the above, it is important to arrange high-frequency access data to an optimal memory area in a program.

A scheme of examining access data with a simulator to provide optimal data arrangement has been proposed as a data arrangement scheme (see, for example, JP-A-9-282290). Though having the capability of simulating a high access cost (the number of execution cycles), this scheme has the following problems (a) to (c).

(a) It takes time for the simulator to trace instructions one by one.

(b) The simulator cannot acquire accurate information originating from a problem unique to a real machine environment (delay of access latency or the like).

(c) There is no means of acquiring data access frequency information in a real machine environment.

As apparent from the above, there is a demand for a method of acquiring data access frequency information in a real machine environment, not in a simulator environment.

The following is the summary of the above-described two tuning schemes which optimally arrange data accessed from a program to improve the program performance and reduce consumed power.

(1) A tool such as a compiler automatically determines an optimal data arrangement based on static source information before execution of a program.

(2) A user specifies data to be accessed from a program at a high frequency to arrange the data in a fast memory.

However, achieving those schemes shall face the following problems.

The scheme (1), if applied to a location of a code which is not executed frequently, does not bring about a significant effect because the frequency of data accesses in a program cannot be grasped.

With regard to the scheme (2), it is practically impossible for a user to specify data to be accessed from a program at a high frequency because there is no means to acquire the access cost (the number of cycles) for data accesses from a program in a real machine environment. Further, while a simulator can simulate a high access cost (the number of execution cycles), the scheme (2) has the problems such that (a) it takes time because the simulator traces instructions one by one unlike in a real machine environment, (b) accurate information originating from a problem unique to a real machine environment (delay of access latency or the like) cannot be acquired, (c) there is no means of acquiring data access frequency information in a real machine environment.

### SUMMARY OF THE INVENTION

It is an aspect of the embodiments discussed herein to provide a profiling apparatus including a program execution section that executes an target program, an interrupt generation section that generates an interruption every predetermined time, a gathering section that is activated upon occurrence of the interruption to gather a data access destination in the target program and a number of interruptions at the data access destination, and a display section that displays information gathered by the gathering section.

These together with other aspects and advantages which will be subsequently apparent, reside in the details of construction and operation as more fully hereinafter described and claimed, reference being had to the accompanying drawings forming a part hereof, wherein like numerals refer to like parts throughout.

The above-described embodiments of the present invention are intended as examples, and all embodiments of the present invention are not limited to including the features described above.

### BRIEF DESCRIPTION OF THE DRAWINGS

FIG. 1 illustrates conventional profiling;

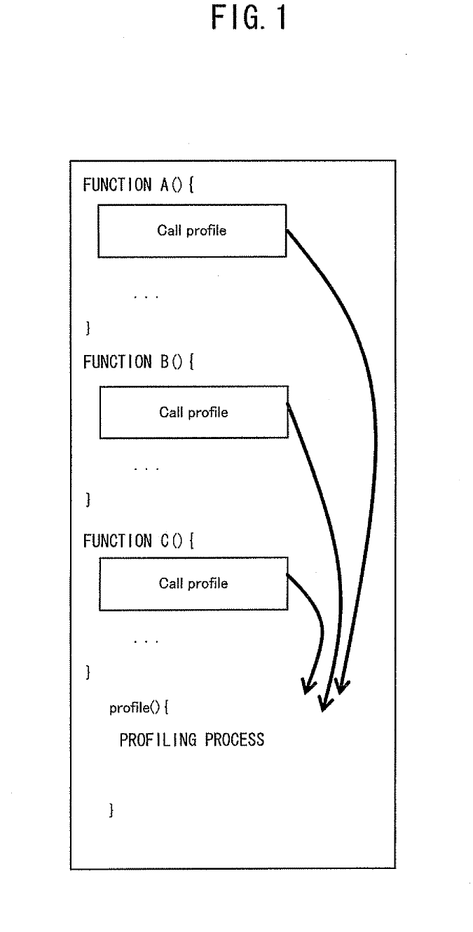

FIG. 2 illustrates the outline of a profiling apparatus of a first embodiment;

FIG. 3 illustrates an example of the hardware configuration of the profiling apparatus;

FIG. 4 illustrates the functions of the profiling apparatus;

FIG. 5 illustrates a table;

FIG. 6 illustrates the relationship between an access cost and a data definition position;

FIG. 7 illustrates a flowchart showing the process of an interruption information acquiring section;

FIG. 8 illustrates an example of arrangement intended for the memory hierarchy;

FIG. 9 illustrates the functions of a profiling apparatus of a second embodiment;

FIG. 10 illustrates a table according to the second embodiment;

FIG. 11 illustrates display data according to the second embodiment which is displayed on a monitor;

FIG. 12 illustrates the functions of a profiling apparatus of a third embodiment;

FIG. 13 illustrates a table according to the third embodiment;

FIG. 14 illustrates display data according to the third embodiment which is displayed on a monitor; and

FIG. 15 illustrates the process of an interruption information acquiring section according to the third embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Embodiments will be described below in detail with reference to the accompanying drawings.

To begin with, the outline of the first embodiment will be explained, followed by the description of the embodiment.

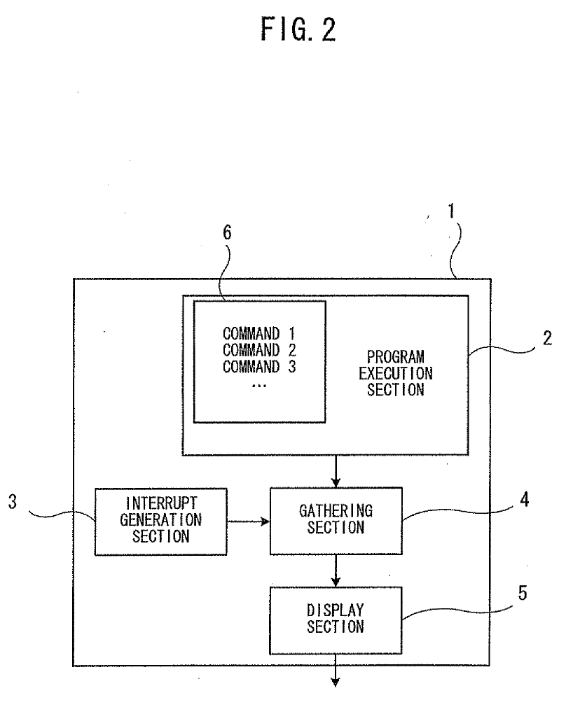

FIG. 2 is a diagram illustrating the outline of the embodiment.

A profiling apparatus 1 has a program execution section 2, an interrupt generation section 3, a gathering section 4 and a display section 5.

The program execution section 2 executes an target program 6.

The interrupt generation section 3 generates an interruption every predetermined time with a timer or the like.

The gathering section 4 is activated upon occurrence of the interruption to gather a data access destination in the target program 6 and the number of interruptions at the data access destination.

The display section 5 displays information gathered by the gathering section 4. That is, the display section 5 displays the data access destination, the number of interruptions, and information originating from processing of those pieces of information so that a user is easy to see the information.

The profiling apparatus 1 executes the target program 6 using the program execution section 2. The interrupt generation section 3 generates an interruption every predetermined time. The gathering section 4 is activated upon occurrence of the interruption to gather a data access destination in the target program 6 and the number of interruptions at the data access destination. The display section 5 displays information gathered by the gathering section 4.

The first embodiment will be described below.

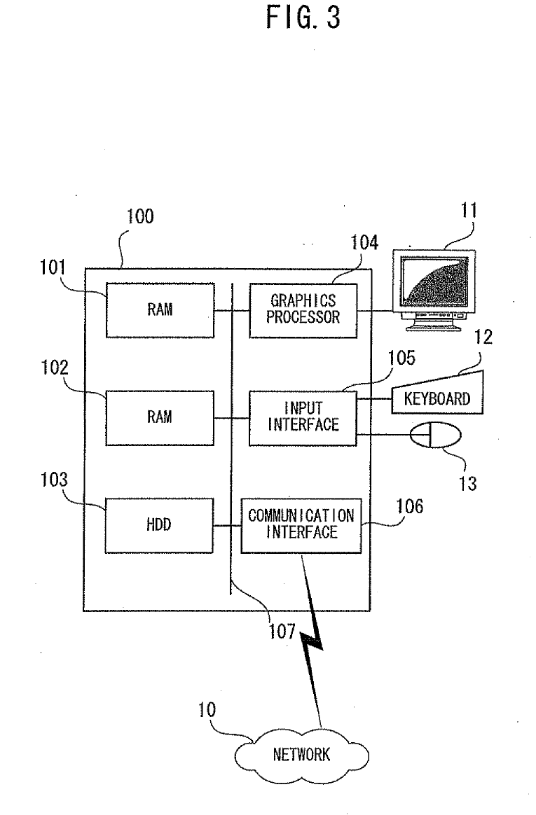

FIG. 3 is a diagram illustrating an example of the hardware configuration of a profiling apparatus.

A profiling apparatus 100 is generally controlled by a CPU 101. The CPU 101 is coupled with a RAM 102, a hard disk drive (HDD) 103, a graphics processor 104, an input interface 105, and a communication interface 106 via a bus 107.

The CPU 101 generates an interruption every predetermined time acquired by, for example, a built-in timer or the like. When an interruption occurs, the CPU 101 saves data or the like which is handled by a running program into the RAM 102, and calls an interruption handler according to the type of an interruption request. When the handler ends, the CPU 101 returns the saved data and resumes the program.

When an OS (Operating System) which is executed by the CPU 101 is installed in the profiling apparatus, at least a part of the program thereof or an application program is temporarily stored in the RAM 102. Various kinds of data needed in processes which are executed by the CPU 101 are stored in the RAM 102.

The OS, when installed in the profiling apparatus or an application program (e.g., an target program or a profiling program for executing profiling) is stored in the HDD 103. Program files are stored in the HDD 103. A ROM (Read Only Memory) may be used in place of the HDD 103.

A monitor 11 is coupled to the graphics processor 104. The graphics processor 104 displays an image on the screen of the monitor 11 according to a instruction from the CPU 101.

The input interface 105 is coupled with a keyboard 12 and a mouse 13. The input interface 105 sends a signal sent from the keyboard 12 or the mouse 13 to the CPU 101 via the bus 107.

The communication interface 106 is coupled to a network 10. The communication interface 106 transmits and receives data to and from another computer over the network 10.

The foregoing hardware configuration can realize the processing capabilities of the embodiment. The following functions are provided for the profiling apparatus 100 with the hardware configuration to execute profiling.

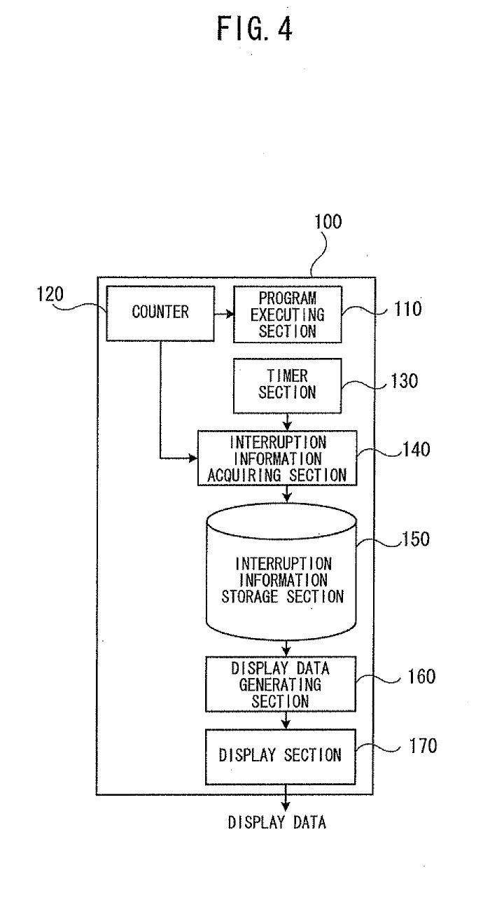

FIG. 4 is a block diagram illustrating the functions of the profiling apparatus.

The profiling apparatus 100 has a program executing section 110, a counter 120, a timer section 130, an interruption information acquiring section 140, an interruption information storage section 150, a display data generating section 160 and a display section 170.

The program executing section 110 executes a program (target program) read from the HDD 103 or the like.

The counter 120 is a program counter built in the CPU 101 (register where an address for a instruction to be read next by the CPU 101 is stored), and holds an address where a instruction to be executed next is stored when the program executing section 110 starts executing a program. The CPU 101 reads the instruction stored at the address to execute a program.

The timer section 130 is constituted by one function of the CPU 101 and generates an interruption every predetermined time (every given number of cycles). A measuring time as granularity (unit of segmentation of a process) can be customized by arbitrarily designating the interval between interruptions to be generated. As the timer is directly designated, the interruption interval can be set finely. Regardless of the presence or absence of an OS environment, the interruption interval can be designated arbitrarily. Under the OS environment, the interruption interval can further be designated arbitrarily by using the timer function of the OS.

The interruption information acquiring section (gathering section) 140 functions as the interruption handler and acquires a count value of the counter 120 every time an interruption occurs.

The interruption information acquiring section 140 determines the machine language of the program counter (register where an address for a instruction to be read next by the CPU 101 is stored), specifies a data address (data access destination), and calculates an access frequency. A method of specifying a data address will be described later

The interruption interval is a constant cycle and is proportional to the number of cycles needed to execute the instruction. That is, the number of interruptions for each data access can be transformed into a data access cost (data access frequency) which could not be acquired conventionally.

The interruption information storage section 150 holds a table 151 for storing gathered information.

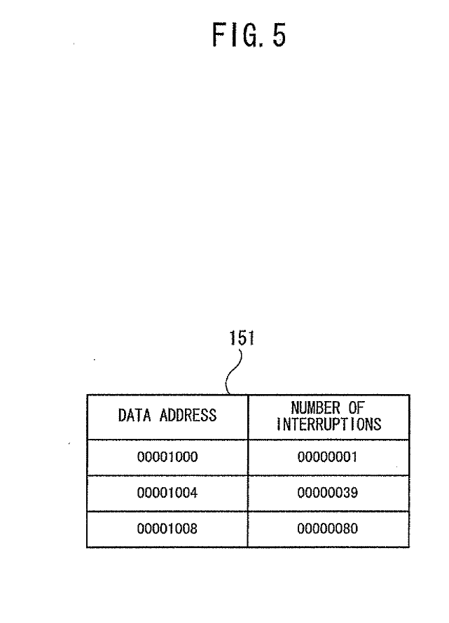

FIG. 5 is a diagram illustrating the table 151.

The table 151 is provided with columns for data addresses and the numbers of interruptions. Pieces of information arranged side by side in the horizontal direction in the columns are associated with each other.

A data address when an interruption occurs is set in the data address column.

The number of interruptions for each data address is set in the interruption number column.

The display data generating section 160 acquires a data address and the number of interruptions stored in the table 151, calculates a data definition position corresponding to the data address, and creates display data for presenting visual display of the calculated data definition position and a change in the number of interruptions in comparison with each other. For example, display data having the data definition position set on the X axis and the number of interruptions set on the Y axis is created. The data definition position can be defined by a source name, a function, a variable name, an intra-variable relative address, a size, etc,

While the display data generating section 160 can be constituted by the CPU 101, it may be constituted by another processor.

The display section 170 displays display data created by the display data generating section 160 on the monitor 11 in the form of a two-dimensional graph. Viewing the graph, a user can observe a behavior such as at which data position (variable name, size) an access cost (the number of interruptions) is high, which could not be grasped conventionally.

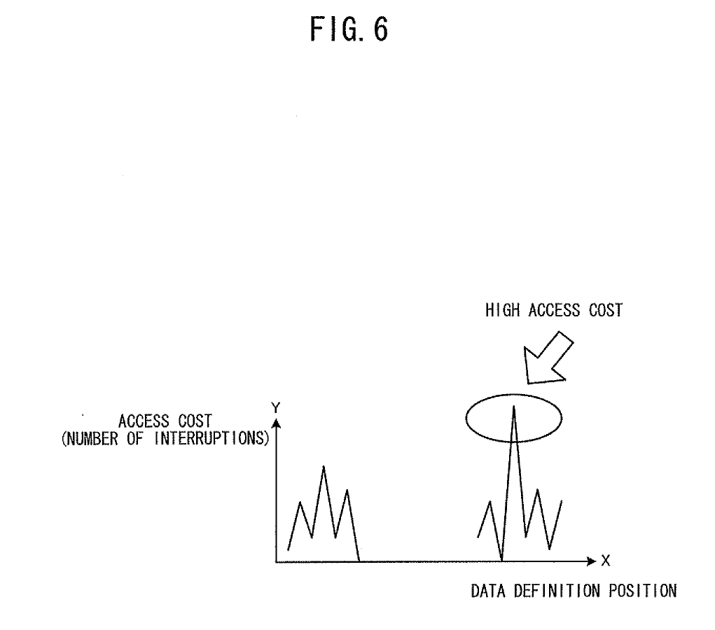

FIG. 6 is a diagram illustrating the relationship between an access cost and a data definition position.

A data definition position at which an access cost is high can be specified by the aforementioned source name, function, address and so forth. It is apparent that an access cost is high around the address encircled by a circle in FIG. 6.

Next, a description will be given of how the interruption information acquiring section 140 specifies a data address.

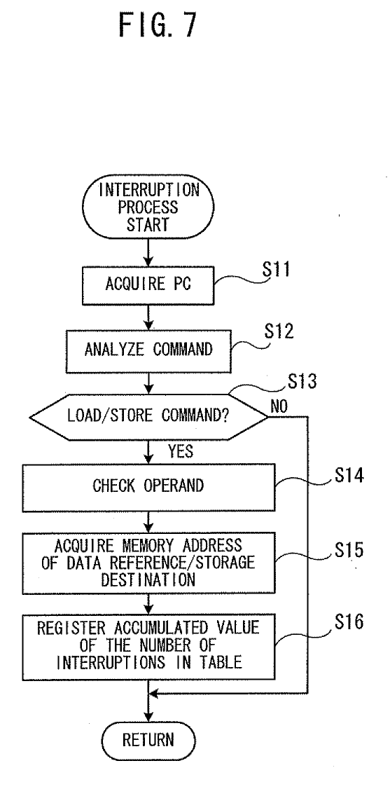

FIG. 7 is a flowchart illustrating the process of the interruption information acquiring section 140.

First, when an interruption occurs, the interruption information acquiring section 140 acquires a program counter (PC) in a program running at the time of occurrence of the current interruption (operation S11). The range of codes of the then acquired may be designated to narrower the acquisition range of a target execution program.

Next, a corresponding instruction is read from the program counter and is analyzed (operation S12). Specifically, the type of a instruction upon occurrence of the interruption is checked based on a machine language indicated by the corresponding program counter. In general, a machine language has a instruction type (opcode) and register information (operand) stored therein. Based on the opcode of the machine language, therefore, the interruption information acquiring section 140 determines whether the instruction is a load instruction (instruction to refer to data) or a store instruction (instruction to set data) (operation S13).

When the instruction upon occurrence of the interruption is neither a load instruction nor a store instruction (operation S13: No), the process is terminated.

When the instruction upon occurrence of the interruption is a load instruction or a store instruction (operation S13. Yes), on the other hand, the operand stored in the machine language is checked (operation S14). The number of a register and an immediate address to be accessed by the load instruction or the store instruction can be acquired from the operand.

Next, a memory address of a data reference/storage destination is acquired based on a value stored at the acquired register number and the acquired immediate address (operation S15).

Then, the corresponding number of interruptions is acquired (overwritten) in the table 151 as a sequential accumulated value (operation S16).

The scheme of determining the instruction type of the interruption instruction and acquiring a data address is a general-purpose type which does not depend on a specific processor architecture.

The process of the interruption information acquiring section 140 will be explained next by way of specific examples.

Let us consider a processor having the following instruction system as an example.

### EXAMPLE 1

### LD @(gr10, gr12), gr4

The value (content) of a data address indicated by register number gr10 added with register number gr12 is set at register number gr4. In this case, an address acquired by register number gr10+register number gr12 is a data address. When the value at register number gr10 is 1000 and the value at register number gr12 is 4, for example, “1” is added (overwritten) in the interruption number column corresponding to the field of the data address “11004” in the table 151.

### EXAMPLE 2

### LDi @(gr10, 8), gr4

The value of a data address indicated by register number gr10+8 is set at register number gr4. In this case, an address acquired by register number gr10+8 is a data address. When the value at register number gr10 is 1000, for example, “1” is added in the interruption number column corresponding to the field of the data address “1008” in the table 151.

According to the profiling apparatus 100 of the embodiment, as described above, the interruption information acquiring section 140 determines the machine language of the program counter of the target program upon occurrence of an interruption. The interruption information acquiring section 140 specifies a data address and calculates an access frequency, making it possible to acquire a data access cost (the number of execution cycles) which could not be acquired conventionally. It is therefore possible to easily and surely grasp a variable area or a portion which has a high cost of memory access (the number of execution cycles) to the zone of a variable area. Accordingly, optimization of data arrangement which has been carried out based on experience and guess can be handled quickly, thus significantly reducing the number of tuning steps to improve the performance and reduce power consumption.

In addition, it is possible to provide data arrangement intended for the memory hierarchy, which picks up only high-cost variables and arranges the variable in a fast memory area (cache memory or RAM built in the CPU) by priority and which would conventionally be difficult to achieve.

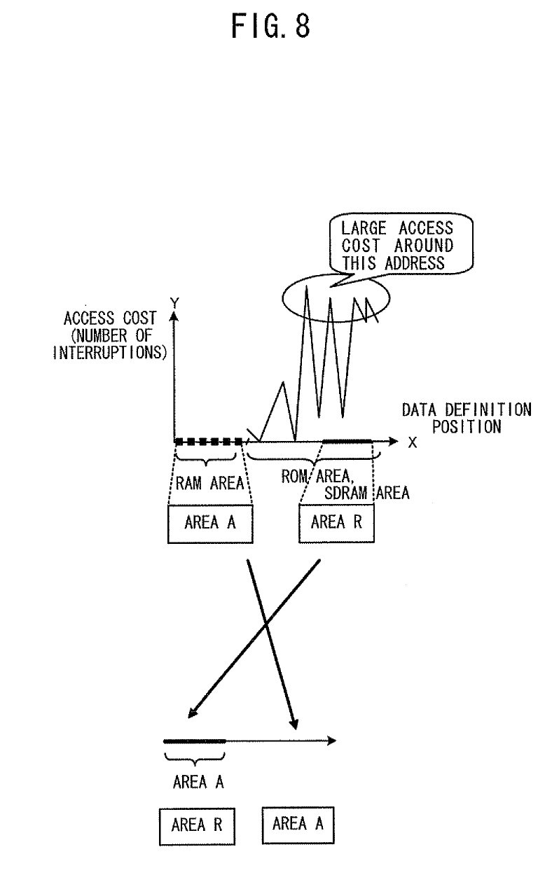

FIG. 8 illustrates an example of arrangement intended for the memory hierarchy.

When an area with a large access cost (area R) is a ROM area or SDRAM area (slow access area), and an area with a small access cost (area A) is a RAM area (fast access area), the definition of the area R is rearranged in the area A. This can make the speed of the target program faster.

In addition to the effect of the foregoing example, it is possible to arrange a specific work area (data area, stack area, heap area) in a fast memory (RAM built in the CPU). It is also possible to arrange a specific work area in another bank in the SDRAM, and allocate a specific variable to a register. In the case of a processor with a data cache, it is possible to set a high-cost variable resident in the cache and lock the cache and adopt prefetching to avoid a data cache miss or hide a cache miss penalty. Taking these measures can improve the performance of the profiling apparatus and reduce the power consumption thereof.

Because profiling can be carried out in a real machine environment, the profiling process can be executed with higher accuracy and quicker as compared with a case of executing simulation using a simulator or the like.

The embodiment can be used both in an OS non-installed environment and an OS environment. The register used upon occurrence of an interruption is used directly in executing the operation S16 without the OS. In the OS environment, the register value is saved upon occurrence of an interruption as a context by the OS in an internal area thereof that area is referred to directly.

Next, a profiling apparatus according to a second embodiment will be described.

The following will mainly describe differences of the profiling apparatus of the second embodiment from that of the first embodiment, and a description of similar parts will be omitted.

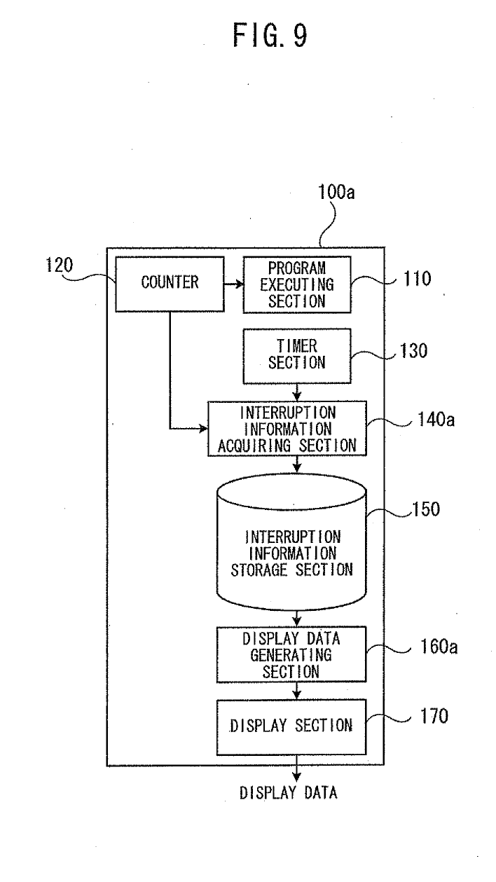

FIG. 9 is a block diagram illustrating the functions of a profiling apparatus 100a of the second embodiment.

The profiling apparatus 100a of the second embodiment differs from the profiling apparatus of the first embodiment in the functions of an interruption information acquiring section 140a and a display data generating section 160a.

In an interruption process, the interruption information acquiring section 140a further acquires a program counter upon occurrence of the interruption in addition to a data address and the number of interruptions, and stores the program counter in a table.

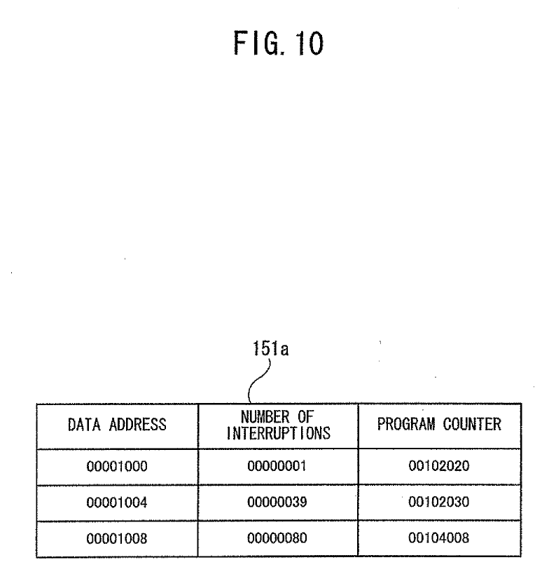

FIG. 10 is a diagram illustrating a table 151a according to the second embodiment.

The table 151a is provided with a program counter column.

The display data generating section 160a acquires a data address, the number of interruptions and a program counter stored in the table 151a. The display data generating section 160a calculates a program position (function name, process, assembler instruction) corresponding to the acquired program counter. The display data generating section 160a creates display data having the calculated program position in comparison with the data access position and the number of interruptions. For example, display data having the data definition position set on the X axis, the program position set on the Y axis and the number of interruptions set on the Z axis is created. Note that a function, a process and an assembler instruction at the program position are associated with one another using symbol information, debug information, etc. in the target program.

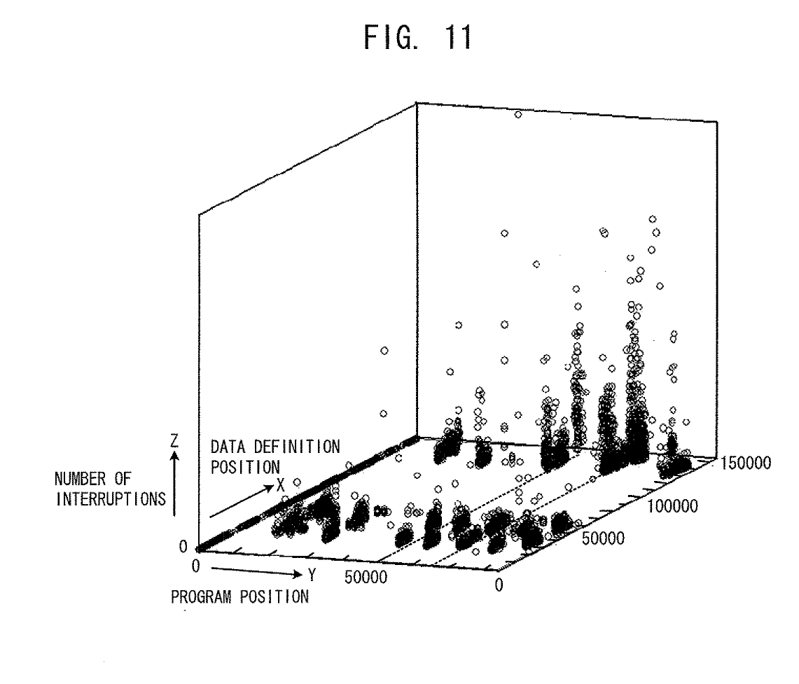

FIG. 11 is a diagram illustrating display data according to the second embodiment which is displayed on a monitor.

A user can observe the position in the program three-dimensionally (each granularity units of the function, the process and the assembler instruction), and a data access at which a high-cost memory access has occurred, by referring to the data definition position in the program. It is apparent from FIG. 10 that an access cost is high around data definition positions 120000 to 150000 (unit: bytes) and around program positions 50000 and 65000 (unit: bytes).

The profiling apparatus 100a of the second embodiment obtains effects similar to those of the profiling apparatus of the first embodiment.

It is possible to easily and surely acquire information effective in accurately adjusting or designing a program or a system with finer granularity because the display section 170 presents visual display of a data definition position in an target program, an access cost and a program position in the form of a three-dimensional graph in the profiling apparatus 100a of the second embodiment. This is effective in optimization on description of a profiling code as well as the aforementioned rearrangement of data. That is, a high access cost at a program position section any one of a case (1) where a instruction cache miss occurs, a case (2) where there is a large number of program executions in which a processor having a cache hits cache, and a case (3) where there is a large number of program executions by a processor which does not have a cache. With respect to a program position whose access cost is high, adjustment on a program can be carried out with various countermeasures, such as (1) reduction in instruction cache misses (changing the arrangement of program instruction positions, reducing branches, reducing a program size, etc.) for the processor with the cache, and (2) reduction in the number of program executions regardless of the presence or absence of a cache to thereby improve the program. This can ensure easy and reliable improvement of the performance of the target program and reduction in consumed power.

Further, only the relationship between a sampling value and a program position would be grasped conventionally, whereas the relationship among a data definition position, a program position and a sampling value can be grasped according to the display data as shown in FIG. 11. When processors or the like which share a instruction bus and a data bus suffer a contention between a instruction access cost and a data access cost, for example, one example of a counter measure to avoid such a contention is to change a instruction arrangement and data arrangement to shift the access timings. Multi-decision is possible from the relationship among a data definition position, a program position and a sampling value, thus ensuring easy and reliable improvement of the performance of the apparatus and reduction in consumed power, which could not be achieved conventionally.

Next, a profiling apparatus according to a third embodiment will be described.

The following will mainly describe differences of the profiling apparatus of the third embodiment from that of the first embodiment, and a description of similar parts will be omitted.

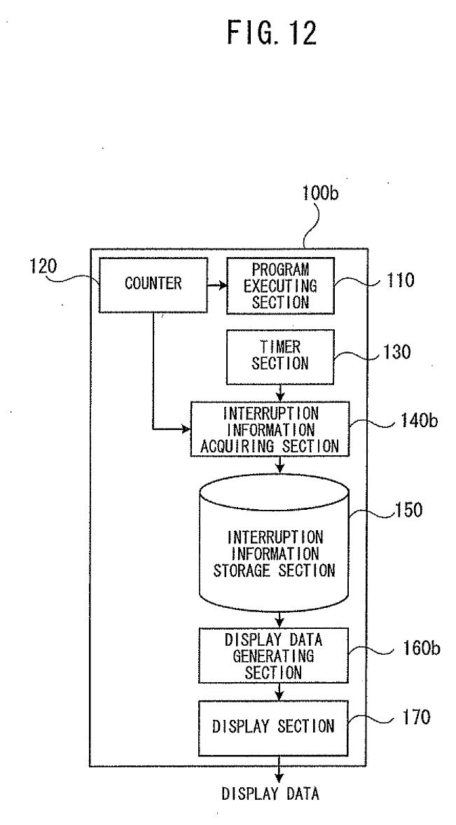

FIG. 12 is a block diagram illustrating the functions of a profiling apparatus 100b of the third embodiment.

The profiling apparatus 100b of the third embodiment differs from the profiling apparatus of the first embodiment in the functions of an interruption information acquiring section 140b and a display data generating section 160b.

The interruption information acquiring section 140b of the third embodiment gathers differential information between a previous access time and a current access time for the same data access destination for each data address, and stores the differential information in the interruption information storage section 150 (for each reference, each setting, each reference/setting). The differential information can be considered as a data access interval. It can be construed that the shorter the access interval is, the higher the locality is, and the longer the access interval is, the lower the locality is.

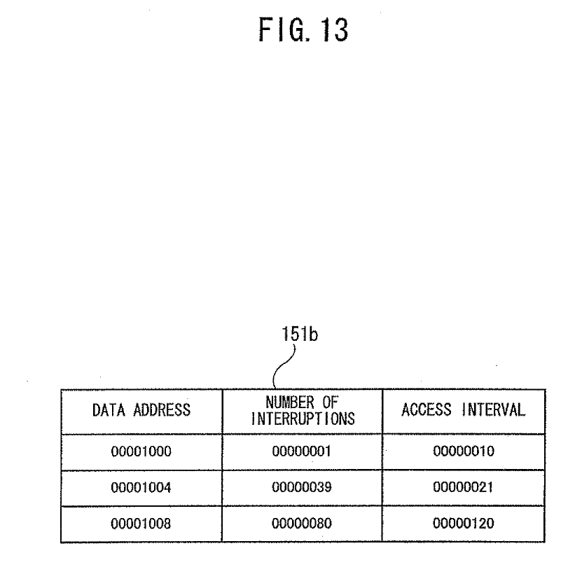

FIG. 13 is a diagram illustrating a table 151b according to the third embodiment.

The table 151b is provided with an access interval column.

The differential information is set in the access interval column.

The display data generating section 160b acquires an access interval stored in the table 151b, and creates display data having a data definition position set on the X axis and the access interval set on the Y axis. Data definitions are displayed in association with variable names of a corresponding source program. The association is made using symbol information, debug information, etc. in a program file.

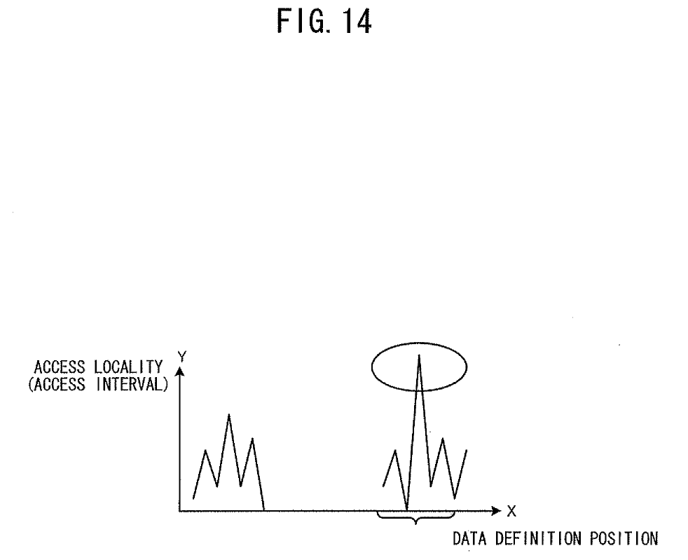

FIG. 14 is a diagram illustrating display data according to the third embodiment which is displayed on a monitor.

A data definition position with a large access locality can be specified by the source namer function, address and so forth. It is apparent that the access locality is large around the address encircled by a circle in FIG. 14.

Next, a description will be given of how the interruption information acquiring section 140b specifies a data address.

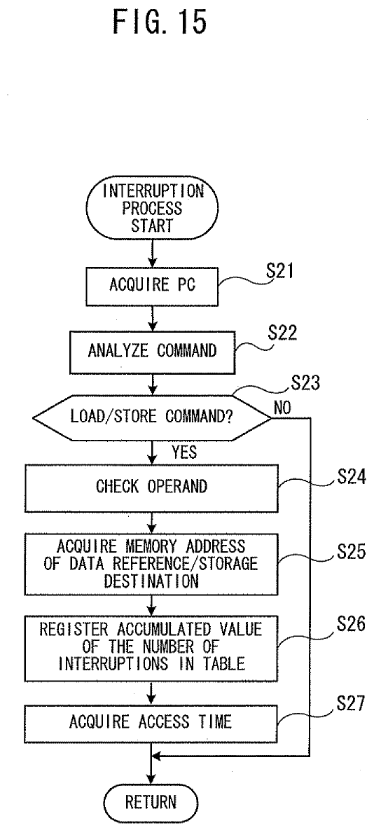

FIG. 15 is a flowchart illustrating the process of the interruption information acquiring section according to the third embodiment.

Operations S21 to S26 are the same as operations S11 to S16, respectively.

An access time is acquired (operation S27). The access time is acquired from the following equation.

access time=access interval+(current access time−previous access time)

The profiling apparatus 100b of the third embodiment provides effects similar to those of the profiling apparatus 100 of the first embodiment.

The profiling apparatus 100b of the third embodiment can set the residential time in the cache longer by rearranging data with a high locality, e.g., arranging data with a high locality in the cache, thus speeding up the processing of the target program.

Although the access interval (differential information) is used as information indicative of the locality in the third embodiment, the embodiment is not limited to this particular mode, but the ratio of residence in the cache per access which is obtained by dividing the differential information by the number of accesses may be used as information indicative of the locality. This is because there are multiple cache misses in the case of sampling data. It is construed that the shorter the residential-in-cache ratio is, the higher the locality of the information becomes, and the longer the residential-in-cache ratio is, the lower the locality of the information becomes. The above is merely an example, and the locality can be defined arbitrarily based on the access interval (differential information) to be used as a general-purpose index.

Although the process relating to a data access destination obtained by acquiring an interruption-occurred program counter (process relating to a data access made by data reference/setting) is executed in each of the above-described embodiments, the embodiments are not restrictive, and a target from which the interruption information acquiring section will acquire information can be a specific instruction designated by a user (an arbitrary instruction for division, subtraction or the like). In this case, display data indicating the relationship between a instruction definition position for the specific instruction and an access cost or display data indicating the relationship between a data definition position, a program position and the number of interruptions is created.

A target from which the interruption information acquiring section will acquire information can be any instruction.

The profiling apparatus and profiling program according to the embodiment have been explained referring to the illustrated embodiment, but are in no way restrictive. The structure of each section can be replaced with any structure which has similar functions. Any other structure or operation may be added to the embodiment.

The embodiment may be a combination of arbitrary two or more structures (features) of each of the above-described embodiments.

The embodiment can be adapted by pseudo generation of a timer-based interruption in a simulator.

The embodiment can be adapted to a processor having a hardware counter which monitors the performance by counting internal events in the processor and external events which are carried out externally. In this case, an interruption which is generated every given time may be used as a trigger for gathering information as mentioned above, or the state of the hardware counter upon occurrence of any event may be used as a trigger. Specifically, a case of acquiring the number of execution cycles as an index is replaced with an event which has caused a data cache miss. This allows an interruption to be generated by a cache-miss occurred instruction, making it is possible to analyze the access destination of the cache miss by analyzing the cache-miss occurred instruction.

The above-described processing functions can be realized by a computer. In this case, a program describing the contents of the processes of the functions that the profiling apparatus 100, 100a, 100b should have is provided. As the computer executes the program, the processing functions are realized on the computer. The program describing the process contents can be recorded on a computer readable recording medium. Computer readable recording mediums include a magnetic recording device, an optical disk, a magneto-optical recording medium, and a semiconductor memory, for example. A hard disk drive (HDD), a flexible disk (FD) or a magnetic tape, for example, are available as the magnetic recording device. A DVD (Digital Versatile Disc), DVD-RAM (Random Access Memory), CD-ROM (Compact Disc Read-Only Memory) or CD-R (Recordable)/RW (ReWritable), for example, are available as the optical disk. An MO (Magneto-Optical disk), for example, is available as the magneto-optical recording medium.

For distribution of a program, a portable recording medium recording the program, such as a DVD or CD-ROM, is to be sold. The program can be stored in a storage device in a server computer, and can be transferred to another computer from the server computer.

The computer that executes a profiling program stores a program recorded on a portable recording medium or a program transferred from the server computer into its local storage device. Then, the computer reads the program from the local storage device, and executes a process according to the program. The computer can directly read the program from the portable recording medium and execute a process according to the program. In addition, the computer can execute a process according to a program received every time the program is transferred from the server computer.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A profiling apparatus comprising:
a program execution section executing an target program;
an interrupt generation section generating an interruption every predetermined time;
a gathering section activated upon occurrence of the interruption to gather a data access destination in the target program and a number of interruptions at the data access destination; and
a display section displaying information gathered by the gathering section.

2. The profiling apparatus according to claim 1, wherein the gathering section acquires a program counter where the interruption has occurred, and determines a machine language of the acquired program counter to gather the data access destination.

3. The profiling apparatus according to claim 2, wherein the gathering section gathers the data access destination when a type of the machine language of the acquired program counter is a load instruction or a store instruction.

4. The profiling apparatus according to claim 1, wherein upon occurrence of the interruption, the gathering section gathers the data access destination by referring to a register at a time of occurrence of the interruption.

5. The profiling apparatus according to claim 1, wherein in case where the profiling apparatus has an operating system, upon occurrence of the interruption, the gathering section gathers the data access destination by referring to an area saved in an internal area of the operating system.

6. The profiling apparatus according to claim 1, further comprising display data creating section that calculates a data definition position corresponding to the data access destination and creates display data for displaying the calculated data definition position on the display section in comparison with the number of interruptions.

7. The profiling apparatus according to claim 1, wherein the gathering section acquires a program counter where the interruption has occurred, and
the profiling apparatus further comprises display data creating section that calculates a program definition position comprised of granularity units of a corresponding function, process and assembler instruction from the acquired program counter, and creates display data for displaying the calculated program definition position on the display section together with the data access destination and the number of interruptions in comparison therewith.

8. The profiling apparatus according to claim 1, wherein the gathering section gathers differential information between a previous access time and a current access time for the same data access destination, and
the profiling apparatus further comprises display data creating section that calculates a data definition position corresponding to the data access destination and creates display data for displaying the calculated data definition position on the display section together with the gathered differential information in comparison therewith.

9. The profiling apparatus according to claim 1, wherein the interrupt generation section generates the interruption, triggered by occurrence of an arbitrary event of a hardware counter.

10. A profiling program that allows a computer to function as:
a program execution section that executes an target program;
an interrupt generation section that generates an interruption every predetermined time;
a gathering section that is activated upon occurrence of the interruption to gather a data access destination in the target program and a number of interruptions at the data access destination; and
a display section that displays information gathered by the gathering section.

11. A profiling method comprising:
executing an target program;
generating an interruption every predetermined time;
gathering a data access destination in the target program upon occurrence of the interruption and a number of interruptions at the data access destination; and
displaying information gathered by the gathering section.
